(19) United States
(12) Patent Application Publication
(10) Pub. No.: US 2018/0089509 A1
(43) Pub. Date: Mar. 29, 2018

(54) INFORMATION DELIVERY SYSTEM BASED ON PACKING BOX IMAGE RECOGNITION

(71) Applicant: Hangzhou Yonghua Printing & Packing Co.,Ltd., Hangzhou (CN)

(72) Inventor: Shoudong Hang, Hangzhou (CN)

(73) Assignee: Hangzhou Yonghua Printing & Packing Co.,Ltd.

(21) Appl. No.: 15/344,585

(22) Filed: Nov. 7, 2016

(30) Foreign Application Priority Data
Sep. 28, 2016 (CN) 201610859257.1

(51) Int. Cl. G06K 9/00; G06K 9/46; G06K 9/62; G06K 9/22; G06K 7/10; H04L 29/08; H04W 4/12

(52) U.S. Cl. CPC G06K 9/00671; G06K 9/4604; G06K 9/628; G06K 9/228; G06K 2007/10524; H04L 67/26; H04W 4/12; G06K 2209/25; G06K 7/1092

(57) ABSTRACT

The present invention discloses an information delivery system based on packing box image recognition. The system comprises: a packing box body, wherein a display layer is arranged on a surface of the packing box body, a pixel density of the display layer is different from that of an adjacent region of the display layer, and the display layer is formed by a plurality of regularly arranged pixel particles; a hand-held mobile terminal, used for scanning the display layer to acquire image information, uploading the image information after decoding to a cloud server to acquire, push information, and displaying the information to consumers through a display module; and a cloud server, used for receiving decoded information after the image information is decoded and outputting the push information to the hand-held mobile terminal, so that a code scanning module of the hand-held mobile terminal is easier to automatically focus a code layer to fetch the image information by adjusting a pixel difference between the display layer and surrounding panels thereof on the packing box, and that commodity information is pushed without affecting the aesthetics of the packing box by using pixel particles arranged by specific rules to encode images of the display layer.

### CROSS-REFERENCE TO RELATED APPLICATIONS

This application claims priority benefit of Chinese Patent Application No. 201810859257.1 with a filing date of Sep. 28, 2016. The content of the aforementioned application, including any intervening amendments thereto, are incorporated herein by reference.

### TECHNICAL FIELD

The present invention relates to the technical field of information communication, and more particularly to an information delivery system based on packing box image recognition.

### BACKGROUND OF THE PRESENT INVENTION

As a box body for backing goods, a packing box not only protects the goods from being damaged, but also efficiently shows the value of the goods through modeling and design of the packing box, so as to maximize the interests of commodity trading. A surface of the traditional packing box is often marked only with commodity trademarks, production address, company name and other basic information. With the continuous development of information technology, in order to allow consumers to further understand the performance of commodities or goods manufacturers in details, the box surface is often printed with the identification code such as two-dimensional code, and consumers can obtain the commodity information pushed by the background server by scanning the identification code, such as the packing box proposed by a Chinese patent CN204507532U. An obvious defect of this kind of packing box is that the area taken by the two-dimensional code or the barcode on the display surface of the packing box is too small, and usually these two-dimensional codes are arranged at the corner of the packing box, which cannot attract the attention of consumers and the impulse of scanning the code; therefore a united information communication function is achieved. If the two-dimensional code and other signs are ked on significant areas ref the display surface of the packing, the aesthetic appearance of the box will be affected, thus reducing the buying inclination of consumers, which is urn not conducive to the communication of the information of businesses.

### SUMMARY OF PRESENT INVENTION

With respect to the problem during practical application that the identification codes such as two-dimensional codes on commodity packing boxes cannot well delivery commodity push information, the present invention provides an information delivery system based on packing box image recognition, with the specific solution as follows:

An information delivery system based on packing box image recognition, comprising:

a packing box body, wherein a surface of the packing box body is printed with a display layer for displaying a commodity trademark, a pixel density of the display layer is different from that of an adjacent region of the display layer, and the display layer is formed by a plurality of regularly arranged pixel particles;

a hand-held mobile terminal, comprising a code scanning module, a decoding module and an information transceiving and displaying module, wherein the hand-held mobile terminal scans the display layer to acquire image information, uploads the image information after decoding by the decoding module to a cloud server to acquire background push information linked to the image information; or the decoding module directly acquires push information comprised by the display layer itself, and displays the information to consumers through a display module; and

a cloud server in communication connection with the hand-held mobile terminal, used for receiving decoded information after the image information is decoded and outputting the push information corresponding to the decoded information to the hand-held mobile terminal.

Through the above technical solution, the traditional sense of identification code is modified to a display layer with specific rules, and by setting different pixel densities around the display layer, it is easier to realize automatic focusing and capturing the display layer when taking pictures in the use of hand-held mobile terminals such as mobile phones etc. Since the display layer is composed of a plurality of particles arranged with specific rules, the decoding module of the hand-held mobile terminal generates decoded information based on the image information, and the cloud server receives the decoded information and delivers the push information corresponding to the decoded information to the hand-held mobile terminal of the consumer. The solution makes full use of the large area of display surface on packing boxes, without affecting the aesthetic appearance of the publicity images on packing boxes and meanwhile attracting the attention of consumers, and the simple operation steps can also stimulate the enthusiasm of consumers to scan the code, thus facilitating the push of commodity information.

Further, the code scanning module comprises a camera and an image recognition and fetching module, wherein the camera captures the image information, and the image recognition and fetching module is connected with the camera and can automatically focus and capture the fetched image based on a pixel density difference of the display layer and a rule difference of the pixel particles.

Through the above technical solution, the image information on packing boxes can be conveniently captured by mobile phones and other hand-held mobile terminals.

Further, the decoding module comprises a decoding algorithm module built into the hand-held mobile terminal, and the decoding algorithm module decodes the image information with a preset rule and generates decoded information.

Through the above technical solution, with the built-in decoding algorithm, the hand-held mobile terminal can decode the image information into corresponding decoded information, such as the encoding of a matrix sequence and the like.

Further, the cloud server comprises:

a database, comprising a data access bus and interface, an image information storage area, and a push information storage area corresponding to the image information;

a decoding module for receiving the decoded information and generating instruction information in accordance with the preset rule; and

an information push module, comprising a query module and a sending module, wherein the query module receives the instruction information and calls the corresponding push information in the information storage area according to a path indicated by the instruction information, and the sending module receives the push information and sends the push information to the hand-held mobile terminal.

Through the above technical solution, the cloud server can quickly respond to the request of the user when the cloud server receives the request, and then send the push information to the hand-held mobile terminal of the consumer.

Further, the push information comprises a commodity display video, a commodity specification, and commodity details.

Through the above technical scheme, the service features and product features of the businesses can be displayed in a more detailed and accurate way, to realize a very good publicity effect.

Further, the sending module comprises a GPRS communication module, a 4G communication module, or a WIFI wireless communication module.

Further, the predetermined rules steps of the decoding module comprises: processing a median filtering, an edge detection, a moment invariant calculation, and an object matching to the decoded information, if the matching is successful, then the instruction information corresponding to the decoded information is output.

Through the above technical solution, the decoding module can accurately and quickly identify the information contained in the decoded information.

Further, the pre-determined locations of the display layer is provided with a positioning pixel block and an anti-counterfeit pixel block that are used for scanning of the code scanning module, and the anti-counterfeit pixel block is composed of a plurality of printed material layers with different light reflectivity.

Through the above technical solution, firstly, the time of image scanning and positioning by the code scanning module can be shortened, secondly, by setting a pixel block with an anti-counterfeit function in a predetermined place, a can be detected whether the product is authentic.

Further, the hand-held mobile terminal comprises a smart phone or a tablet computer.

With the popularity of smart phones and tablet computers, through the above technical solution, consumers can easily facilitate the scanning of the display layer and get the corresponding push information.

Further, an arrangement rule of the pixel particles is as follows:

a plurality of the positioning pixel blocks are arranged on the display layer, and the image information is located in an area enclosed by a plurality of the positioning pixel blocks;

a plurality of content displaying pixel blocks take an edge of the area enclosed by the plurality of positioning pixel blocks as a benchmark, divide the enclosed area into n classes of recognition areas from the outside to the inside, and mark the n classes of recognition areas as class n, class n-1, class n-2. . . . , and n-n+1 recognition areas from the outside to the inside;

if a corner angle of an contour edge of the image information on the display layer is less than a preset value, a first recognition pixel block is arranged at the corner; and

if the contour edge of the image information on the display layer is a continuous curve, a second recognition pixel block is arranged in the middle part of the continuous curve.

Further, the algorithm steps of the image information decoding algorithm module are as follows:

S1, receiving the graphic information, captured by the camera, taking a recognition area enclosed by straight connected lines of two adjacent positioning pixel blocks as a benchmark, dividing the recognition area into several pixel grids with equal shapes and sizes, and for pixel grids located in the edge of the recognition area, if ½ of the area of the pixel grids lies in the recognition area, setting the pixel grids as an area to be recognized;

S2, detecting a network pattern or network speed of the hand-held mobile terminal;

if the network pattern is a WIFI pattern, packaging, and sending the data from the class n to the class n-m-t to the decoding module;

if the network pattern is a 4G pattern, packaging and sending the data from the class n to the class n-j-t to the decoding module; and

if the network pattern is a GPRS pattern, packaging and sending the data from the class n to the class n-k-t to the decoding module;

wherein, m<j<k, and m, j, k, and t are all positive integers; and m, j, k represent the value of recognition classes for different network patterns during initial set up of the system, and t represents the cyclic running times of the decoding algorithm;

S3, receiving the packaged data in step S2, sending the packaged data to the decoding module, detecting quantities and shapes of the first recognition pixel blocks and the second recognition pixel blocks in each class of recognition areas, matching the detected data with the data in the database, if the match is successful, outputting the corresponding push information; and if the match fails, then jump to step S2 to continue execution.

Compared with the prior art, the advantages effects of the invention are as follows:

(1) By adjusting the pixel difference between the display layer and surrounding panels thereof on the packing box, the code scanning module of the hand-held mobile terminal is easier to automatically focus the code layer to fetch the image information;

(2) By using pixel particles arranged by specific rules, the image of the display layer is encoded, achieving the push of commodity information without affecting the aesthetics of the packing box.

(3) By setting specific arrangement rules and algorithms of pixel particles, the recognition efficiency of graphic information can be effectively improved.

### DESCRIPTION OF THE DRAWINGS

FIG. 1 is a schematic diagram of a system structure of the present invention;

FIG. 2 is a schematic diagram of a packing box used with a hand-held mobile terminal;

FIG. 3 is a schematic diagram of encoding of image pixel particles; and

FIG. 4 is a schematic diagram of a decoding process of a decoding module.

Reference numerals: 1. packing box body; 2, hand-held mobile terminal; 3, cloud server; 11. display layer; 12. pixel particle; 121, positioning pixel block; 122. anti-counterfeit pixel block; 123. first recognition pixel block; 124. second recognition pixel block; 21. code scanning module; 22, decoding module; 23. information transceiving module; 24, display module; 211 camera; 212, image recognition and fetching module; 31. database 311. image information storage area; 312. push information storage area; 32. decoding module; 33. information push module; 34. query module; 35 sending module.

### DETAILED DESCRIPTION OF PREFERRED EMBODIMENTS

In the prior art, identification codes for scanning are often arranged at the corner of packing boxes, which cannot attract the attention of consumers and the impulse for scanning the code, therefore a limited information communication function is achieved. In view of the problems mentioned above, the present invention proposes an information delivery system based on packing box image recognition.

The present invention will be further described in detail below in conjunction with the accompanying drawings and embodiments; however the embodiments of the present invention are not limited thereto.

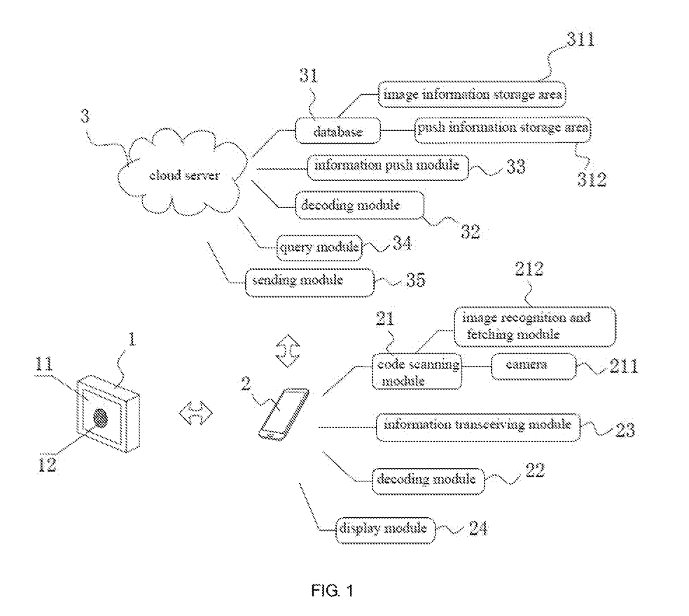

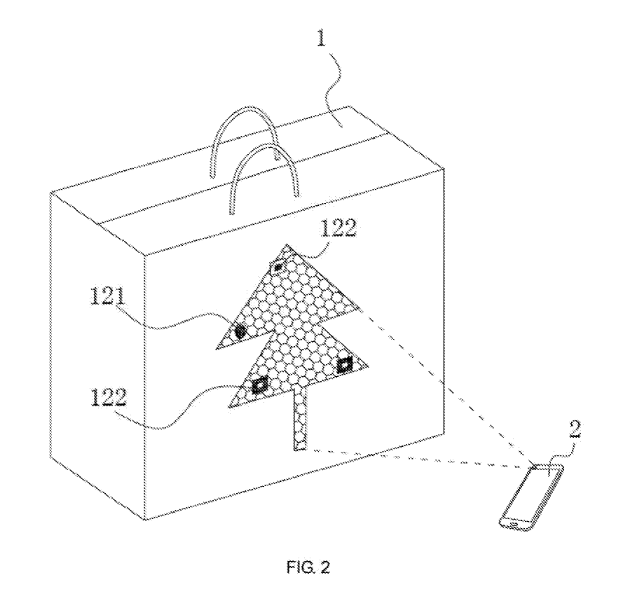

As shown in FIG. 1 and FIG. 2, an information delivery system based on packing box image recognition mainly comprises three parts: a packing box body 1, a hand-held mobile terminal 2, and a cloud server 3.

A surface of the packing box body 1 is printed with a display layer 11 for displaying a commodity trademark, a pixel density of the display layer 11 is different from that of an adjacent region of the display layer, and the display layer 11 is formed by a plurality of regularly arranged pixel particles 12 for scanning; as the automatic focus of the present mobile phone is achieved by using an approach of mechanical focus plus algorithm processing software, wherein the mechanical approach is to achieve focus changes through an automatic fore and after movement of the camera lens, and the second algorithm focus is more focused on searching for detecting pixel differences of the areas adjacent to the object so as to initiate the focus. The technique of the mechanical focus and the algorithm processing software focus has been widely used in all hand-held mobile terminals 2 with a camera function. In order to facilitate the camera of the hand-held mobile terminal 2 to capture the object to be captured, the best solution is to improve the pixel difference between the target image and the around images, so that the hand-held mobile terminal 2 can more easily focus the focal point onto the target image. In the present invention, when the automatic focus is completed, the image information is automatically taken into the hand-held mobile terminal 2, and this technology is widely used in the current online code scanning payment. By setting the code with specific rules to the image information as a whole, the solution makes full use of the large area of display surface on packing boxes, without affecting the aesthetic appearance of the publicity images on packing boxes and meanwhile attracting the attention of consumers, and the simple operation steps can also stimulate the enthusiasm of consumers to scan the code, thus facilitating the push of commodity information.

Optimally, in order to enhance the anti-counterfeit of the commodity packing box, and improve the efficiency of the code scanning module 21, the pre-determined locations of the display layer 11 is provided with a positioning pixel block 121 and an anti-counterfeit pixel block 122 that are used for scanning of the code scanning module 21, and the anti-counterfeit pixel block is composed of a plurality of printed material layers with different light reflectivity. The positioning pixel block is arranged at a specific position, and the positioning time of the code scanning module 21 is shortened by locking the positioning pixel block. The anti-counterfeit of pixel blocks is composed of a plurality of printed material layers with different light reflectivity, such as reflective scales made of plastic films, by adding different doses of additives in the plastic films, the reflection rate of the plastic films varies, the reflected color varies, and the image information obtained during the scanning also varies, thus can improve the imitation difficulty of the whole display layer 11, and serve for anti-counterfeit.

For the hand-held mobile terminal, it mainly comprises a code scanning module 21, a decoding module 22 and an information transceiving and displaying module 24, wherein the hand-held mobile terminal 2 scans the display layer 11 to acquire image information, after the image information is decoded by the decoding module 22 and is uploaded to a cloud server 3, a background push information linked by the image information is acquired, or the push information contained in the display layer is directly acquired by the decoding module, and the information display the information to consumers through a display module 24; in detail, the code scanning module 21 comprises a camera 211 and an image recognition and fetching module 212, wherein the camera 211 captures the image information, and the image recognition and fetching module 212 can automatically focus and capture the fetched image based on a pixel density difference of the display layer 11 and a rule difference of the pixel particles 12. Through the above technical solution, the image information on packing boxes can be conveniently captured by mobile phones and other hand-held mobile terminals 2.

In further detail, the decoding module 22 comprises a decoding algorithm module built into the hand-held mobile terminal 2, and the decoding algorithm module decodes the image information with a preset rule and generates decoded information. Through the above technical solution, with the built-in decoding algorithm, the hand-held mobile terminal 2 can decode the image information into corresponding decoded information, such as the encoding of a matrix sequence and the like.

With the popularity of smart phones and tablet computers, in the present invention, through the hand-held mobile terminals 2 such as smart phones and tablet computers, the above technical solution can make the customers easily facilitate the scanning of the display layer 11 and get the corresponding push information.

In decoding image information, usually there are a lot of original images need to be compared, and the original images can only be stored in the cloud database 31, on this occasion, the image information of the first layer 11 is uploaded to the cloud server 3, and is compared and decoded in the cloud server 3. For some simple image information or in case that the original images need for comparison are not enough, the original images are built into the hand-held mobile terminal 2, and is compared and decoded by the hand-held mobile terminal 2. In the present invention, there are two approaches in decoding the image information, the first approach is to decode through the decoding module 22 built into the hand-held mobile terminal 2, to obtain the push information contained in the image information, such as URL links, image information, etc., namely directly obtain the push information contained and carried by the display layer 11 itself. The second approach is to upload the image information, and then through the decoding module 22 arranged in the cloud server 3 to recognize and decode the code. Deciding which approach is adopted is based on the size and quantity of the image information, so as to reach a fastest decoding speed.

For the second decoding approach, the invention hereby provides the arrangement rules of pixel particles and the method for decoding in the later steps as follows:

the pixel particle arrangement rules are as follows:

the plurality of positioning pixel blocks is arranged on the display layer, and the image information is located in the area enclosed by a plurality of the positioning pixel blocks; the plurality of content displaying pixel blocks set the edge of the area enclosed by the plurality of positioning pixel blocks as a benchmark, and the enclosed area from the outside to the inside is divided into n classes of recognition areas, from outside to inside are in turn marked as class n, class n-1, class n-2, . . . , n-n+1 recognition area; if the corner angle of contour edge of the image information on the display layer is less than the preset value, then the first recognition pixel blocks 123 is arranged at the corner; if the contour edge of the image information on the display layer is a continuous curve, then the middle part of the continuous curve is provided with a second recognition pixel blocks.

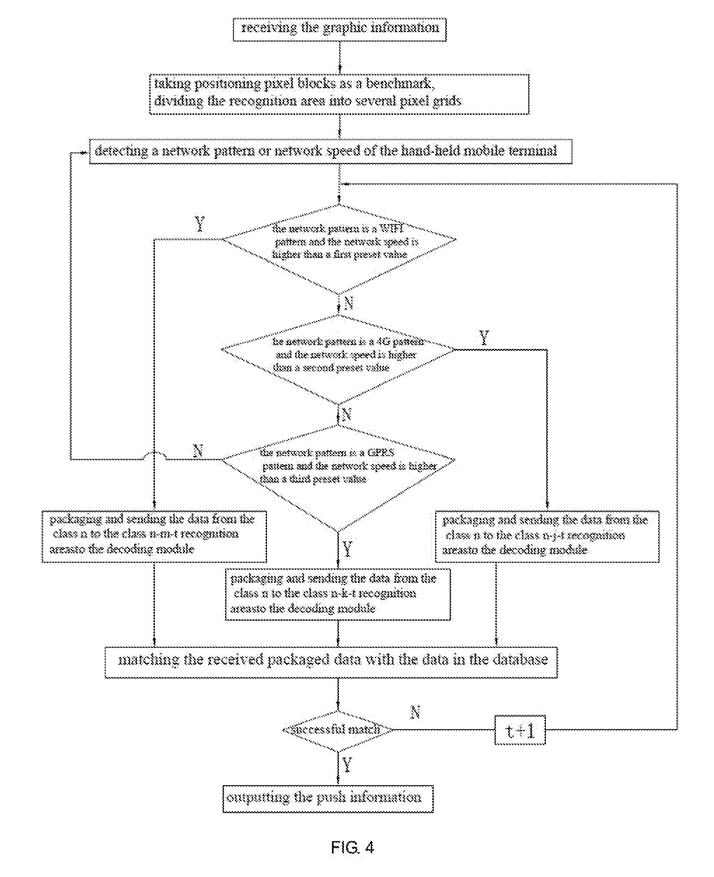

Further, as shown in FIG. 4, the algorithm steps of the image information decoding algorithm module are as follows:

S1, receiving the graphic information captured by the camera, taking a recognition area enclosed by straight connected lines of two adjacent positioning pixel blocks as a benchmark, dividing the recognition area into several pixel grids with equal shapes, and sizes, and for pixel grids located in the edge of the recognition area, if ½ of the area of the pixel grids lies in the recognition area, setting the pixel grids as an area to be recognized;

S2, detecting a network pattern or network speed of the hand-held mobile terminal;

if the network pattern is a WIFI pattern, packaging and sending the data from the class n to the class n-m-t to the decoding module;

if the network pattern is a 4G pattern, packaging and sending the data from the class ,n to the class n-j-t to the decoding module; and

if the network pattern is a GPRS pattern, packaging and sending the data from the class n to the class n-k-t to the decoding module;

wherein, m<j<k, and 111, j, k, and t are all positive integers; and m, j, k represents the value of recognition classes for different network patterns during initial set up of the system, and t represents the cyclic running times, of the decoding algorithm;

S3, receiving the packaged data in step S2, sending the packaged data to the decoding module, detecting quantities and shapes of the first recognition pixel blocks and the second recognition pixel blocks in each class of recognition areas, matching the detected data with the data in the database, if the match is successful, outputting the corresponding push information; and if the match fails, then jump to step S2 to continue execution.

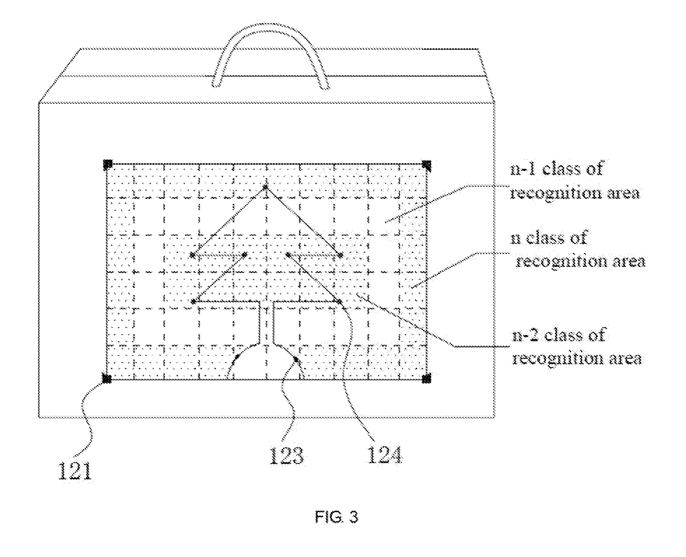

As shown in FIG. 3, positioning blocks in 4 different shapes are arranged on the display layer, an enclosed area can he made through two adjacent positioning pixel blocks being connected with straight lines, this area is a recognition area, in the inner part of the recognition area, the recognition area is divided into a plurality of pixel grids (these pixel grids are automatically generated by the decoding module and are not printed on the display layer), starting from the edge of the recognition area, from the outside to the inside, the recognition area is divided into a plurality of recognition areas, correspondingly, a plurality of the first recognition blocks 123 or the second recognition blocks 124 may be contained in respective classes of recognition areas, it is also possible that a plurality classes of recognition areas which are close to the edge of the recognition areas are not provided with the first recognition pixel blocks 123 or the second recognition pixel blocks, because the area for recognition is too small. Since the graphics of the first recognition pixel blocks and the second recognition pixel blocks are different, the meaning represented by each recognition pixel blocks are different either, and a higher degree of recognition can be made for different graphics. During the decoding process of the image information, the data of one or more classes of recognition areas which are close to the edge of the recognition areas are firstly delivered to the decoding module, as shown in FIG. 3, in the recognition area of class, n, there are 2 first recognition pixel blocks, and 6 second recognition blocks exist in the recognition area of class n-2, the above data are compared with the data in the database, if the comparison success, i.e. the recognition pixel blocks in the class of recognition area thereof are unique, then the push information corresponding to the recognition results is output, and the whole recognition process ends, if the data contained in the n-1 class of recognition area is not unique, then the recognition range is extended to the class n-1-1 recognition area, the cycle repeats until the recognition is completed. The above solution can effectively improve the recognition efficiency, and in accordance with the network status of the mobile phones and other mobile communication terminals, the size of the initial data packet is determined, if the terminal is in WIFI state, then a plurality of recognition area data are upload, if terminal is not in WIFI state, then less amount of the recognition area data are uploaded, in practical application, the invention also comprises a detection module for detecting the data flow of the mobile communication terminal, determining the amount of the upload data according to the detected value by the detection module.

The cloud server 3 is in communication connection with the hand-held mobile terminal 2 and is used for receiving decoded information after the image information is decoded and outputting the push information corresponding to the decoded information to the hand-held mobile terminal 2. The cloud server 3 comprises: a database 31, comprising a data access bus and interface, an image information storage area 311, and a push information storage area 312 corresponding to the image information; a decoding module 32, for receiving the decoded information, and generating instruction information in accordance with the preset rule; and an information push module 33, comprising a query module 34 and a sending module 35, wherein the query module 34 receives the instruction information and calls the corresponding push information in the information storage area 312 according to a path indicated by the instruction information, and the sending module 35 receives the push information and sends the push information to the hand-held mobile terminal 2. The cloud server 3 can quickly respond to the request of the user when the cloud server receives the request, and then send the push information to the hand-held mobile terminal 2 of the consumer.

In order to make the decoding module 32 accurately and quickly identify the information contained in the decoded information, the predetermined rules steps of the decoding module 32 comprises: processing a median filtering, an edge detection, a moment invariant calculation, and an object matching to the decoded information, if the matching is successful, then the instruction information corresponding to the decoded information is output.

In order that the service features and product features of businesses can be displayed in a more detailed and accurate way, and playing a good role in the promotion, the push information comprises commodity display videos, commodity specifications, and commodity details.

The sending module 35 comprises a GPRS communication module, a 4G communication module, or a WIFI wireless communication module. When businesses only promote their commodity in a local range, for example the promotional activities are only conducted in the mall, then the information can be pushed by using the WWI wireless communication module; if the promotional activities are in a large range, then the information can be pushed by using the GPRS communication module or the 4G communication module, in a foreseeable period of time, the above sending module can also adopt a 5G communication module.

In the invention, the traditional identification code is modified to a display layer 11 with specific rules, by setting different pixel densities around the display layer 11, it is easier to realize automatic focusing and capturing the display layer 11 when taking pictures in the use of hand-held mobile terminals 2 such as mobile phones etc., the display layer 11 is composed of a plurality of particles arranged with specific rules, the decoding module 22 of the hand-held mobile terminal 2 generates decoded information based on the image information, the cloud server 3 receives the decoded information and deliver the push information corresponding to the decoded information to the hand-held mobile terminal 2 of the consumer, playing a good role in pushing, the commodity information.

The above mentioned is only preferable embodiments of the invention, the protective scope, of the invention is not limited to the embodiments described, and any technical solution under the concept of the invention belongs to the scope of protection of the invention. It should be noted that ordinary technical personnel in the field can make some improvements and modifications without departing from principles of the invention, and these improvements and modifications shall still fall within the protection scope of the invention.

I claim:

1. An information delivery stem based on packing box image recognition, characterized by comprising:
a packing box body (1), wherein a surface of the packing box body (1) is printed with a display layer (11) for displaying a commodity trademark, a pixel density of the display layer (11) is different from that of an adjacent, region of the display layer, and the display layer (11) is formed by a plurality of regularly arranged pixel particles (12);
a hand-held mobile terminal (2), comprising a code scanning module (21), a decoding module (22) and an information transceiving and displaying module (24), wherein the hand-held mobile terminal (2) scans the display layer 11) to acquire image information, uploads the image information after decoding by the decoding module (22) to a cloud server to acquire background push information linked to the image information; or the decoding module (22) directly acquires push information comprised by the display layer 11) itself, and displays the information to consumers through a display module (24);
a cloud server (3) in communication connection with the hand-held mobile terminal (2), receiving decoded information after the image information is decoded and outputting the push information corresponding to the decoded information to the hand-held mobile terminal (2).

2. The information delivery system based on packing box image recognition according to claim 1, characterized in that the code scanning module (21) comprises a camera (211) and an image recognition and fetching module (212), wherein the camera (211) captures the image information, and the image recognition and fetching module (212) is connected with the camera (211) and can automatically focus and capture the fetched image based on a pixel density difference of the display layer (11) and a rule difference of the pixel particles (12).

3. The information delivery system based ort packing box image recognition according to claim 1, characterized in that the decoding module (22) comprises a decoding algorithm module built into the hand-held mobile terminal (2), and the decoding algorithm module decodes the image information with a preset rule and generates decoded information.

4. The information delivery system based on packing box image recognition according to claim 2, characterized in that the cloud server (3) comprises:
a databases (3), comprising a data access bus and interface, an image information storage area (311), and a push information storage area (312) corresponding to the image information;
a decoding module (32) for receiving the decoded information, and generating instruction information in accordance with the preset rule; and
an information push module (33), comprising a query module (34) and a sending module (35), wherein the query module (34) receives the instruction information and calls the corresponding push information in the push information storage area (312) according to a path indicated by the instruction information, and the sending module (35) receives the push information and sends the push information to the hand-held mobile terminal (2).

5. The information delivery system based on packing box image recognition according to claim 4, characterized in that the sending module (35) comprises a GPRS communication module, a 4G communication module, or a WIFI wireless communication module.

6. The information delivery system based on packing box image recognition according to claim 3, characterized in that a pre-determined location of the display layer is provided with a plurality of positioning pixel blocks (121), anti-counterfeit pixel blocks, and recognition pixel blocks that are used for scanning of the code scanning module the anti-counterfeit pixel block (122) is composed of a plurality of printed material layers with different light reflectivity, and a plurality of the positioning pixel blocks and the recognition pixel blocks are arranged with different shapes.

7. The information delivery system based on packing box image recognition according to claim 6, wherein an arrangement rule of the pixel particles is as follows:
a plurality of the positioning pixel blocks are arranged on the display layer, and the image information is located in an area enclosed by a plurality of the positioning pixel blocks;
a plurality of content displaying pixel blocks take an edge of the area enclosed by the plurality of positioning pixel blocks as a benchmark, divide the enclosed area into n classes of recognition areas from the outside to the inside, and mark the n classes of recognition areas, as class n, class n-1 class n-2, . . . , and n-n+1 recognition areas from the outside to the inside;
if a corner angle of an contour edge of the, image information on the display layer is less than a preset value, a first recognition pixel block is arranged at the corner; and
if the contour edge of the image information on the display layer is a continuous curve, a second recognition pixel block is arranged in the middle part of the continuous curve.

8. The information delivery system based on packing box image recognition according to claim 7, wherein algorithm steps of the image information decoding algorithm module are as follows:
S1, receiving the graphic information captured by the camera, taking a recognition area enclosed by straight connected lines of two adjacent positioning pixel blocks as benchmark, dividing the recognition area into several pixel grids with equal shapes and sizes, and for pixel grids located in the edge of the recognition area, if ½ of the area of the pixel grids lies in the recognition area, setting the pixel grids as an area to be recognized;
S2, detecting a network pattern or network speed of the hand-held mobile terminal;
if the network pattern is a WIFI pattern, packaging and sending the data from the class n to the class n-m-t to the decoding module;
if the net work pattern is a 4G pattern, packaging and sending the data from the class n to the class n-j-t to the decoding module; and if the network pattern is a GPRS pattern, packaging and sending the data from the class n to the class n-k-t to the decoding module;
wherein, m<j<k, and m, j, k, and t are all positive integers; and m, j, k represent the value of recognition classes for different network patterns during initial set up of the system, and t represents the cyclic running times of the decoding algorithm;
S3, receiving the packaged date in step S2, sending the packaged data to the decoding module, detecting quantities and shapes of the first recognition pixel blocks (123) and the second recognition pixel blocks (124) in each class of recognition areas, matching the detected data with the data in the database, if the match is successful, outputting the corresponding push information; and if the match fails, then jump to step S2 to continue execution.

9. The information delivery system based on packing box image recognition according to claim 4, characterized in that the hand-held mobile terminal (2) comprises a smart phone or a tablet computer.
